(19) United States
(12) Patent Application Publication
(10) Pub. No.: US 2005/0016406 A1
(43) Pub. Date: Jan. 27, 2005

(54) Device and method for correcting a longitudinal register error which is caused by position adjustment

(76) Inventor: Hermann-Josef Veismann, Horstel (DE)

Correspondence Address: JACOBSON HOLMAN PLLC, 400 SEVENTH STREET N.W., SUITE 600, WASHINGTON, DC, 20004, US

(21) Appl. No.: 10/502,042

(22) PCT Filed: Jan. 29, 2003
(86) PCT No.: PCT/EP03/00882

(30) Foreign Application Priority Data
Feb. 5, 2002 (DE) 102 04 514.3

(51) Int. Cl. B41F 13/16

(52) U.S. Cl. 101/486

(57) ABSTRACT

Described is a process for the correction of the longitudinal registration error of a rotary printing press with several inking systems (1-9)
in which a control unit adjusts the desired application line (D) of the printing plate on the material web lying on one of the two rollers by controlling the drive or drives of the two rollers (11, Kₙ) directly involved in the printing process of an inking system, so that the two rollers have, at least during a period of time, a different circumferential speed,
where the control unit takes into account the shift (A) of the actual, effective print line on the circumference of both rollers (11, Kₙ) in the correction
that arises as a consequence of an adjustment movement of one of the two rollers involved in the printing process along an axis (BAₙ) that does not run parallel to the connecting line (Sₙ) of the axes of rotation (Mₙ, M₁₁) of the two rollers involved in the printing process;
by the control unit determining correction values from the relative position of the two rollers (11, Kₙ) directly involved in the printing process of an inking system (N) and the angle (α) between the connecting line (Sₙ) of the axes of rotation of the two rollers involved in the printing process and the axis of adjustment (BAₙ)

The invention relates to a process for the correction of the longitudinal registration error according to the preamble of claim 1.

The printing of multi-color print images with rotary printing presses is done, as a rule, by the print substrate running through various inking systems in sequence, each of said inking systems imparting one color so that the multi-color print image arising arises as an overlay of several print images. Great importance is attached to the precision with which this layering is performed. Shifts of the various print images with respect to one another in the printing direction are called longitudinal registration errors. The deviations called longitudinal registration errors or the circumferential registration errors are, as a rule, corrected by the press operator at the beginning of the printing process by the press operator controlling the relative position of so-called registration marks that are applied by the various inking systems. However, this process has the disadvantage of a long reaction time and the large number of rejects associated therewith.

Thus, DE 195 27 199 proposes, in reference to a flexographic printing press, to register the registration marks with recognition sensors during the entire printing process, to supply the results of the measurement of the sensors to a control and computer unit, and to perform the longitudinal registration correction by the print cylinder being run, at least for a short period of time, at a different circumferential speed than the impression cylinder.

In the application of the process sketched in DE 195 27 199 for the correction of the longitudinal registration error during the entire printing process, it is, however, required that said optical recognition sensors monitor the print image long-term, supply the control unit with measurement signals, whereupon the same performs the control of the speed of the various print rollers necessary for the registration correction.

This process requires, therefore, among other things, a long-term optical monitoring of the print image. Thus, it is the objective of the present invention to propose a process that gets by without long-term monitoring.

This objective is realized by the characterizing clause of claim 1.

The invention is based on the insight that, in proofing presses as well as in the operation of rotary printing presses, there is the necessity of adjusting the position of the rollers involved in the printing process relative to one another. In the circles of those skilled in the art, this adjustment of position is called the adjustment process.

In order to make possible this adjustment process, printing presses have suitable bearing for the rollers involved in the printing process. Thus, from DE 40 01 735 A 1 a flexographic printing press is known in which the carriages carrying the printing rollers and the carriages carrying the color application or anilox rollers are guided in a common carriage guide of the inking system bracket of the printing press and can be traversed, jointly or individually, by spindle drives.

In the case of rotary printing presses of this known type, the adjustment of the print image is normally done as follows. An electronic control device is provided that can access data input into a storage device. The data relate to the adjustment travel between the print roller and the impression roller, taking into account the geometric dimensions of the press and the diameter of the rollers.

This control device then adjusts the relative roller position so that it is supposed to be ensured that all the parts of the print image are transferred.

However, the various rollers, printing plates, the materials to be printed on, and all the other parts involved have geometrical tolerances so that an additional adjustment process often becomes necessary. This adjustment process is done by the printing press operator who adjusts the roller positions while observing the print image.

Through this type of adjustment of the print image, it is ensured that a complete transfer of the print image takes place with the lowest contact pressure of the rollers involved in the printing process against one another. Additional details relating to the adjustment process, which can run completely automatically, are contained in the still unpublished German patent application with the file number 101 45 957.2.

Along with the sketched adjustment to be performed during the contact process, it is often necessary to carry out a so-called dynamic adjustment process. By this, the following is to be understood:

At higher printing speeds changes of the effective diameter of rollers involved in the printing process occur. Affected thereby are, for example, the printing plate rollers in flexographic printing.

The printing plates of these rollers are pressed at the printing line between the printing plate and impression rollers. At higher rotational speeds, the roller no longer reaches its actual radius measured before the printing process, as the restoration speed of the flexible printing plate material is not sufficient. However, with the use of very flexible materials, it is possible that the effective diameter increases as a consequence of the centrifugal force dependent on rotary speed.

In both cases, the pressure between the rollers directly involved in the printing process changes. This situation is addressed with an additional adjustment process, the so-called dynamic adjustment. It is expedient in this connection to perform this type of adjustment automatically by a control unit determining the necessary corrections of the relative positions of the rollers as a function of the often empirically recorded material parameters of the rollers and the printing speeds.

An investigation of the geometric arrangement of the two rollers directly involved in the printing process of an inking system yields, however, that most adjustment movements in printing presses of the known type are done along axes that do not run parallel to the connecting line of the axes of rotation of the two rollers involved in the printing process. Adjustment movements of this type thus induce a shift of the actual effective printing line on the circumference of the rollers. Each shift of the printing line leads to a longitudinal registration error.

Calculations show that the percentage of these errors that are longitudinal registration errors occurring during the printing process is significant and, in part, even exceeds the percentage of all other errors.

Thus, an effective longitudinal registration error correction can be performed with the process according to the invention without the control device being constantly loaded with evaluation and calculation operations, as in the case of the process according to DE 40 01 735 A1. As a rule, the parameters necessary to carry out the process, such as the instantaneous relative position of the rollers of the individual printing presses, are known to the known control units so that the process can be carried out entirely without additional measurement devices, such as expensive optical sensors. Moreover, it is possible to implement the process according to the invention, so that the control device only determines the correction values when changes of the relative position of the rollers have actually been made so that the calculational and control expense is also limited.

Nonetheless, the process according to the invention can be combined with other known processes. Thus, it is possible in the preregistration or at certain intervals of time to check with optical sensors, and to accordingly correct the adherence to registration. However, through the use of the process according to the invention, the necessity of constantly carrying out measurement and calculation processes is eliminated.

Additional embodiment examples of the invention are explained in the description of the object. The figures show:

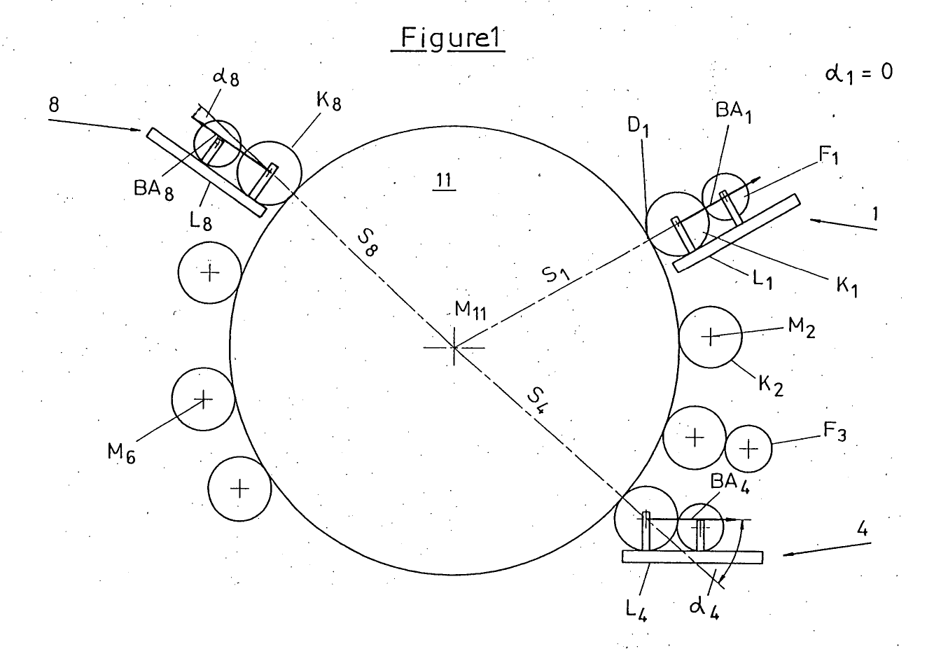

FIG. 1 schematically, a flexographic printing press with a plurality of printing presses,

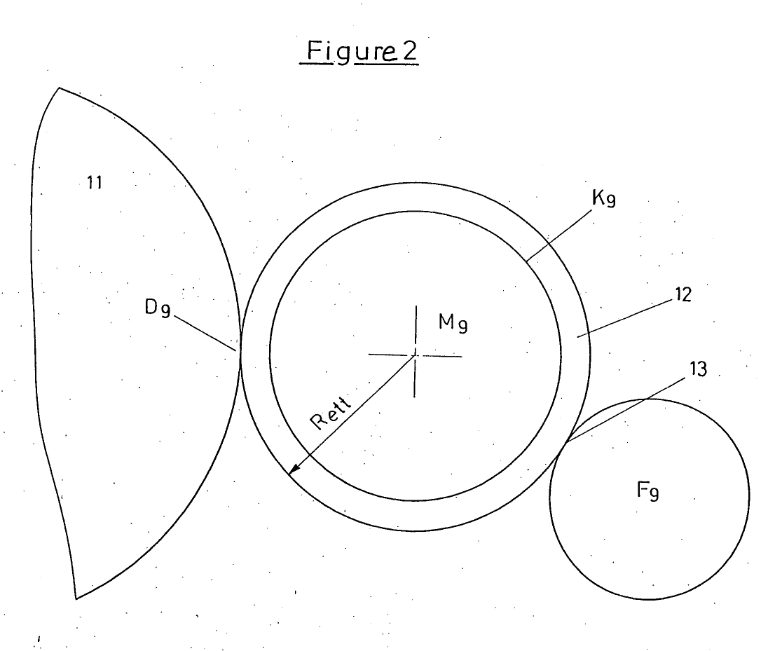

FIG. 2 schematically, a printing plate roller in the printing process,

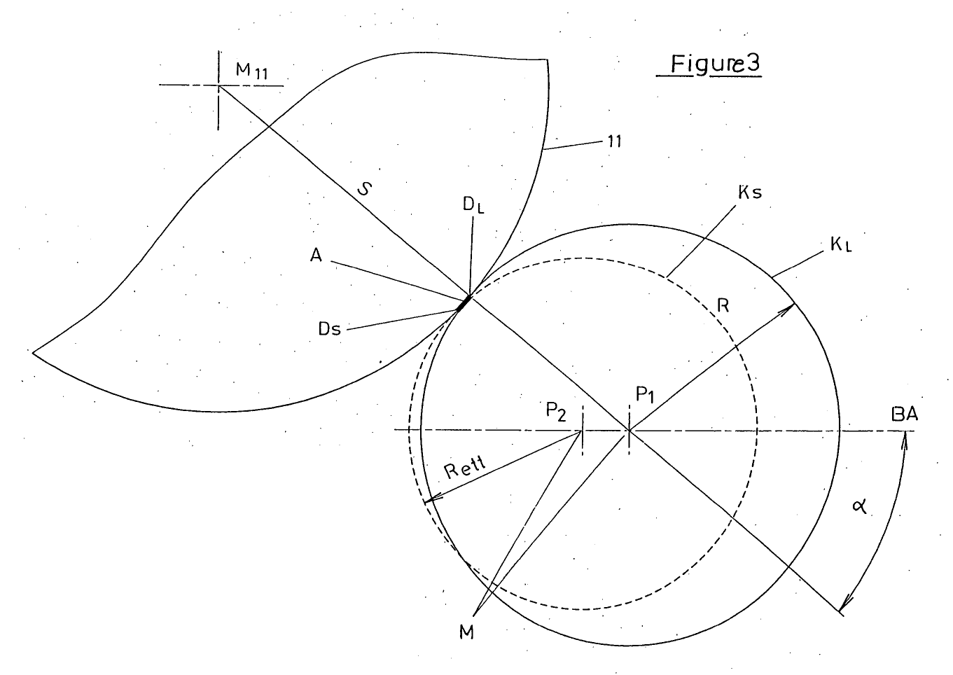

FIG. 3 schematically, the consequences of a dynamic adjustment.

FIG. 1 shows schematically the arrangement of inking systems 1 to 8 of a flexographic printing press 10 around an impression cylinder 11, where only the inking systems 1, 4, and 8 are completely represented. For the other inking systems, only the position of the printing plate rollers is specified. The inking systems are suspended on a press frame that is not represented. The inking systems n (n denotes an arbitrary one of the inking systems present) includes a printing plate roller Kₙ and an inking system Fₙ. The axes of rotation of the printing plate rollers are denoted by Mₙ; and that of the impression cylinder by M₁₁. The lines that are defined by the axes of rotation M₁₁ and Dₙ are denoted by Sₙ. Therein, Dₙ is the print line of the printing plate roller Kₙ on the impression cylinder. Between the lines Sₙ and the axes of the adjustment movement BAₙ angles αₙ arise. The effective print line between the printing plate rollers Kₙ and the impression cylinder 11 are denoted by Dₙ.

The inking systems 1, 4, and 8 show, by way of example, various possibilities for the alignment of the inking systems or the axes of the adjustment movement BA relative to the lines Sₙ, while the other printing systems are merely sketched. Thus, the adjustment axis BA₁ runs on the line S₁, so that, in an adjustment, no shift of the print line results. Such an arrangement would be called a strictly linear arrangement of the inking systems. However, such an arrangement is very demanding from the standpoint of press construction and thus not to be considered relevant for modern printing presses.

An approximately linear arrangement is shown with the aid of inking system 8. The axis of the adjustment BA₈ does not run on the line S₈ and the angle α₈ arises between the adjustment BA₈ and the line S₈. Each adjustment movement of the roller K₈ leads to a shift of the effective print line D₈ on the circumference of the rollers involved, 11 and K₈.

From the standpoint of press technology and manufacturing technology, the simplest variant of the arrangement of an inking system to implement is the so-called drawer arrangement, which is shown with the aid of the inking system 4. Here, the axis of the adjustment BA₄ runs horizontally so that the angle α₄ and the registration error arising due to the adjustment is still greater than in the inking system 8.

FIG. 2 shows, in the example of a printing plate roller K₉, the position of the printing plate cylinder K₉ during the printing process. The printing plate cylinder K₉ and other materials flexibly involved in the printing process, such as the unrepresented rubber coating of the impression cylinder and the also unrepresented print substrate, are exposed to strong forces in the printing process. Thus, the print plate 12 is squeezed between the impression cylinder 11 and the printing plate roller K₉ along the print line D₉. A similar process takes place on the print line 13 between the printing plate roller K₉ and the inking system F₉. In a rapid rotation of the roller K₉ about its axis of rotation M₉, it can occur that the deformation, among other things, of the printing plate on the aforementioned print lines K₉ and 13 is no longer moistened by the restoring forces of the squeezed material 11, 12, K_{g}, before the squeezed material once again reaches the D_{g} or Dₙ. Thus, in this case, the effective radius R_{eff}, which denotes the distance between the outer circumference of the printing plate and the axis of rotation M₉ immediately before the repeated reaching of the print line D₉, is reduced. However, this effective radius R_{eff} is decisive for the quality of the printing process. In the case described above of the shrinking of the effective radius, the physical pressure on the print line can lessen and an effect on the ink transfer to the print substrate can occur. In this case, the press operator or the press control of a flexographic printing press will set the printing plate roller more strongly on the impression cylinder 11.

From the viewpoint of the high centrifugal forces, however, with the use of other materials, an increase of the effective radius R_{eff} can occur, which brings with it an increase of the physical pressure on the print line D₉. In this case, the printing plate roller K₉ is run somewhat further from the impression cylinder 11. In general, both processes are included under the term dynamic adjustment.

FIG. 3 illustrates, in the example of a sketched inking system whose elements are provided with reference numbers without indication of the inking system enumeration, the geometric relationships if the angle a deviates from 0°.

During the contact process, the slowly rotating printing plate roller K_{I}, has a radius R that hardly varies over its entire circumference and is positioned on the impression cylinder 11.

The position and the radius of the rapidly running printing plate roller Kₛ, which is represented here by a dotted line, illustrated the further course of the printing process. In the case of an increase of the printing speed, the radius, relevant for the printing process, of the printing plate roller is reduced in this embodiment example from R to R_{eff}. In order, despite this, to ensure an optimal ink transfer, the axis of rotation M of the printing plate roller is traversed from the position P₁ into the position P₂. The latter position forms the midpoint of the rapidly running printing plate roller K., represented as a dotted line. FIG. 3 shows that the printing plate roller Kₛ, has, due to the adjustment process, a print line Dₛ with the impression cylinder 11, which, at another position, is found as the print line D_{I} of the slowly rotating K_{I}. The interval A between both print lines leads to a longitudinal registration error that is to be remedied with the process according to the invention. It is understood that the change of the radius in the course of the printing process in FIG. 3 was not represented to scale for reasons of representation.

List of Reference Numbers

| | |
|---|---|
| 1 | Inking system |
| 2 | Inking system |
| 3 | Inking system |
| 4 | Inking system |
| 5 | Inking system |
| 6 | Inking system |
| 7 | Inking system |
| 8 | Inking system |
| 9 | Inking system |
| 10 | |
| 11 | Impression cylinder |
| 12 | Printing plate |
| 13 | Print line anilox roller-printing plate roller |
| 14 | |
| M₁₁ | Axis of rotation of the impression cylinder |
| Kₙ | Printing plate roller in the inking system n |
| Kₗ | Slowly running printing plate roller |
| Kₛ | Rapidly running printing plate roller |
| Dₙ | Print line of the printing plate roller Kₙ on the impression cylinder |
| Dₗ | Effective print line of the slowly running printing plate roller Kₗ |
| | on the impression cylinder |
| Dₛ | Effective print line of the rapidly running printing plate roller Kₗ |
| | on the impression cylinder |
| A | Interval Dₗ-Dₛ |
| Rₙ | Radius of the printing plate roller |
| R_{eff} | Effective radius of the printing plate roller |
| Fₙ | Inking roller in the inking system n |
| Mₙ | Axis of rotation of the printing plate roller in the inking system n |
| M_{n,eff} | Midpoint of the circle defined by the radius R_{n,eff} |
| Lₙ | Bearing block for the rollers in the inking system n |
| Sₙ | Line which runs through the points M₁₁ and Dₙ |
| BAₙ | Axis of the adjustment movement of the inking system n |
| αₙ | Angle between Sₙ and BAₙ |
| P₁ | Position of the axis of rotation of the slowly running printing |
| | plate roller |
| P₂ | Position of the axis of rotation of the rapidly running printing |
| | plate roller |

1. Process for the correction of the longitudinal registration error of a rotary printing press with several inking systems (1-9) in which a control unit adjusts the desired application line (D) of the printing plate on the material web lying on one of the two rollers by controlling the drive or drives of the two rollers (11, Kₙ) directly involved in the printing process of an inking system, so that the two rollers have, at least during a period of time, a different circumferential speed,
characterized in that
the control unit takes into account the shift (A) of the actual, effective print line on the circumference of both rollers (11, Kₙ) in the correction,
which arises as a consequence of an adjustment movement of one of the two rollers involved in the printing process along an axis (BAₙ) that does not run parallel to the connecting line (Sₙ) of the axes of rotation (Mₙ, M₁₁) of the two rollers involved in the printing process,
by the control unit determining correction values from the relative position of the two rollers (11, Kₙ), directly involved in the printing process, of an inking system (N) and the angle (α) between the connecting line (Sₙ) of the axes of rotation of the two rollers involved in the printing process and the axis of adjustment (BAₙ).

2. Process according to claim 1,
characterized in that,
in the determination of the correction values, the control unit accesses correction values on a storage device in which the correction values are plotted as a function of the relative roller position.

3. Process according to claim 1,
characterized in that,
in the determination of the correction values, the control unit accesses correction values on a computer unit that determines correction values with the aid of a computational algorithm from the relative position of the two rollers (11, Kₙ), directly involved in the printing process of an inking system (n) and the angle (α) between the connecting line (Sₙ) of the axes of rotation of the two rollers involved in the printing process and the axis of adjustment (BAₙ).

4. Process according to claim 1,
characterized in that
the control unit first performs a preregistration, in particular during the printing process, by evaluating the relative position of components of the print images that is plotted with optical sensors.

5. Process according to claim 1,
characterized in that
the control unit performs, at regular intervals of time, a registration correction by evaluating the relative position of components of the print images that is plotted with optical sensors.

6. Rotary printing press with several inking systems (n)
in which a control unit adjusts the desired application line (D) of the printing plate on the material web lying on one of the two rollers by controlling the drive or drives of the two rollers (11, Kₙ) directly involved in the printing process of an inking system, so that the two rollers have, at least during a period of time, a different circumferential speed,
characterized in that
the control unit takes into account the shift (A) of the actual, effective print line on the circumference of both rollers (11, Kₙ) in the correction
that arises as a consequence of an adjustment movement of one of the two rollers involved in the printing process along an axis (BAₙ) that does not run parallel to the connecting line (Sₙ) of the axes of rotation (Mₙ, M₁₁) of the two rollers involved in the printing process;
by the control unit determining correction values from the relative position of the two rollers (11, Kₙ) directly involved in the printing process of an inking system (N) and the angle (α) between the connecting line (Sₙ) of the axes of rotation of the two rollers involved in the printing process and the axis of adjustment (BAₙ).
